(19) United States
(12) Patent Application Publication
(10) Pub. No.: US 2026/0200712 A1
(43) Pub. Date: Jul. 16, 2026

(54) TRANSPORTER, TRANSPORT SYSTEM, CONTROLLER, CONTROL METHOD, AND STORAGE MEDIUM

(71) Applicant: Kabushiki Kaisha Toshiba, Kawasaki-shi (JP)

(72) Inventor: Yusuke Ito, Yokohama Kanagawa (JP)

(21) Appl. No.: 19/450,543

(22) Filed: Jan. 15, 2026

(30) Foreign Application Priority Data
Jan. 16, 2025 (JP) 2025-006158

(51) Int. Cl. B66F 9/075; B66F 9/06

(52) U.S. Cl. CPC B66F 9/0755; B66F 9/063; B66F 9/07581

(57) ABSTRACT

A transporter of one embodiment includes a detector, a movement mechanism, a setter, a motion planning part, and a movement control part. The detector is configured to detect information on the surroundings of the transporter. The movement mechanism is configured to move the transporter. The setter is configured to set a parameter necessary to create a motion plan for autonomously moving the transporter in accordance with a type of the transport target. The motion planning part is configured to create the motion plan using a detection result of the detector and the parameter set by the setter. The movement control part is configured to control the movement mechanism in accordance with the motion plan created by the motion planning part.

### CROSS-REFERENCE TO RELATED APPLICATION

This application is based upon and claims the benefit of priority from Japanese Patent Application No. 2025-006158, filed on Jan. 16, 2025; the entire contents of which are incorporated herein by reference.

### FIELD

Embodiments described herein relate generally to a transporter, a transport system, a controller, a control method, and a storage medium.

### BACKGROUND

In logistics sites, distribution sites, and other workplaces, robots are increasingly being introduced to address labor shortages. An autonomous mobile robot (AMR) is known as one type of such a robot. The autonomous mobile robot is a robot that utilizes sensing technologies by cameras, sensors, and the like to automatically search for a path and is capable of traveling to a destination while automatically avoiding people or obstacles. Patent Document 1 below discloses an autonomous mobile robot that tows and transports a transport target.

### BRIEF DESCRIPTION OF THE DRAWINGS

FIG. 1 is a side view showing a configuration of a transporter of a first embodiment.

FIG. 2 is a perspective view showing the configuration of the transporter of the first embodiment.

FIG. 3 is a functional block diagram of the transporter of the first embodiment.

FIG. 4 is a flowchart showing a control method of the first embodiment.

FIG. 5 is a view for explaining a method of calculating an outline in the first embodiment.

FIG. 6A is a view for explaining a method of calculating a rotation center, a minimum proximity distance, and a minimum radius of rotation in the first embodiment.

FIG. 6B is a view for explaining a method of calculating the rotation center, the minimum proximity distance, and the minimum radius of rotation in the first embodiment.

FIG. 6C is a view for explaining a method of calculating the rotation center, the minimum proximity distance, and the minimum radius of rotation in the first embodiment.

FIG. 7A is a view for explaining a method of calculating the rotation center, the minimum proximity distance, and the minimum radius of rotation in the first embodiment.

FIG. 7B is a view for explaining a method of calculating the rotation center, the minimum proximity distance, and the minimum radius of rotation in the first embodiment.

FIG. 7C is a view for explaining a method of calculating the rotation center, the minimum proximity distance, and the minimum radius of rotation in the first embodiment.

FIG. 8A is a view for explaining a method of calculating the rotation center, the minimum proximity distance, and the minimum radius of rotation in the first embodiment.

FIG. 8B is a view for explaining a method of calculating the rotation center, the minimum proximity distance, and the minimum radius of rotation in the first embodiment.

FIG. 8C is a view for explaining a method of calculating the rotation center, the minimum proximity distance, and the minimum radius of rotation in the first embodiment.

FIG. 9A is a view for explaining a calculation direction of a path for autonomous travel in the first embodiment.

FIG. 9B is a view for explaining a calculation direction of a path for autonomous travel in the first embodiment.

FIG. 9C is a view for explaining a calculation direction of a path for autonomous travel in the first embodiment.

FIG. 10 is a side view showing a configuration of a transporter of a second embodiment.

FIG. 11 is a functional block diagram of the transporter of the second embodiment.

FIG. 12 is a flowchart showing a control method of the second embodiment.

FIG. 13 is a functional block diagram of a transporter of a third embodiment.

FIG. 14 is a flowchart showing a control of the third embodiment.

FIG. 15A is a view for explaining a margin set in the third embodiment.

FIG. 15B is a view for explaining a margin set in the third embodiment.

FIG. 16 is a functional block diagram of a transporter of a fourth embodiment.

FIG. 17 is a block diagram of a transport system including a transporter of a fifth embodiment.

### DETAILED DESCRIPTION

A transporter of one embodiment includes a detector, a movement mechanism, a setter, a motion planning part, and a movement control part. The detector is configured to detect information on the surroundings of the transporter. The movement mechanism is configured to move the transporter. The setter is configured to set a parameter necessary to create a motion plan for autonomously moving the transporter in accordance with a type of the transport target. The motion planning part is configured to create the motion plan using a detection result of the detector and the parameter set by the setter. The movement control part is configured to control the movement mechanism in accordance with the motion plan created by the motion planning part.

Hereinafter, a transporter, a transport system, a controller, a control method, and a storage medium of embodiments will be described with reference to the drawings. As the transporter of the present embodiment, for example, a transport robot capable of autonomous travel may be used. As the transport robot, specifically, unmanned transport vehicles such as an autonomous mobile robot (AMR) or an automated guided vehicle (AGV) may be used. Also, the transporter of the present embodiment is configured to transport a transport target at, for example, a logistics or manufacturing work site, or a distribution work site in which luggage, products, or the like are loaded in a store backyard or the like.

### First Embodiment

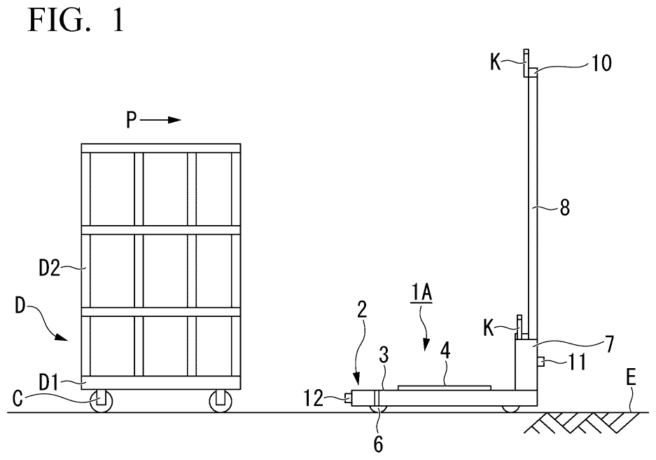

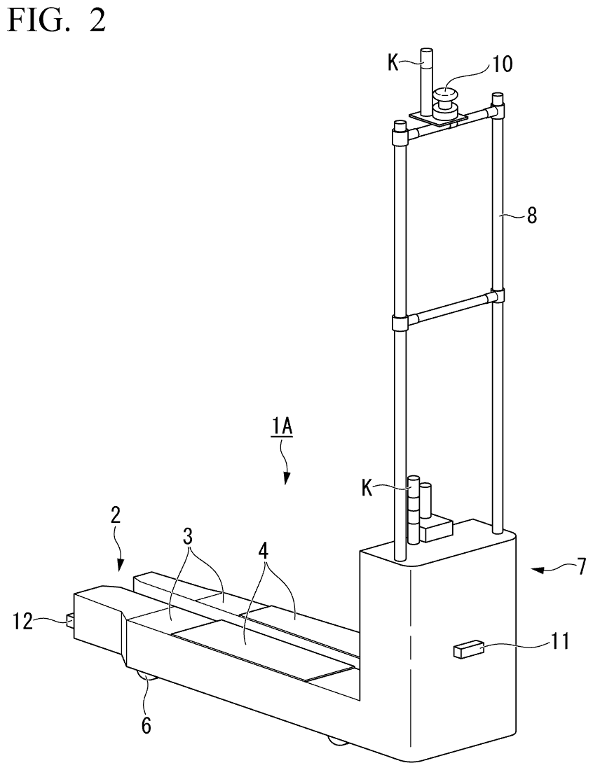

FIG. 1 is a side view showing a configuration of a transporter of a first embodiment. FIG. 2 is a perspective view showing a configuration of the transporter of the first embodiment. As shown in FIGS. 1 and 2, a transporter 1A transports a transport target D. The transport target D is, for example, a cage cart. As the cage cart, a cart in which, for example, a loading platform is surrounded by a mesh or lattice-like steel frame or the like, and wheels for movement are attached beneath the loading platform, may be used. The transport target D includes, for example, a bottom plate D1 formed in a rectangular plate shape, a plurality of wheels C provided on a lower surface side of the bottom plate D1, and a frame body D2 provided on an upper surface side of the bottom plate D1. The plurality of wheels C are an example of a driver of the transport target D.

The transporter 1A transports the transport target D by moving the transport target D while operating the driver of the transport target D. The transporter 1A transports the cage cart by, for example, moving the cage cart while rotating the plurality of wheels C of the cage cart on a floor surface E. Also, for example, each of the plurality of wheels C or any of the plurality of wheels C may use a rotating body (rotating member) that is rotatable within a predetermined rotation range or 360 degrees around an axis intersecting the floor surface E. Also, for example, each of the plurality of wheels C or any of the plurality of wheels C may use, as needed, a fixed member that does not rotate around the axis intersecting the floor surface E. For the wheels C, a member having a so-called caster structure may be used.

An object to be transported (not shown in the drawings) is placed on the upper surface side of the bottom plate D1. On the upper surface side of the bottom plate D1, the frame body D2 is provided to surround the transport target. The frame body D2 is formed to surround four surface sides around the periphery including an upper side of the bottom plate D1. At least one of the four surfaces of the frame body D2 is formed as an openable and closable door. One surface of the frame body D2 may be open without providing a door.

Four wheels C are disposed at four corners on the lower surface side of the bottom plate D1. The plurality of wheels C move the bottom plate D1 with respect to the floor surface E. On the lower surface side of the bottom plate D1, two pairs of wheels C are disposed at a predetermined distance in the direction P in FIG. 1. The two pairs of wheels C are a first set of wheels C and a second set of wheels C, respectively. The wheels C may be fixed wheels or swivel wheels. Of the two pairs of wheels C, for example, one pair of wheels may be fixed wheels, and the other pair of wheels may be swivel wheels. All of the two pairs of wheels C may be swivel wheels. With the above-described configuration, the transport target D travels with respect to the floor surface E, for example, by applying an external force in the direction P in FIG. 1. The transport target D is transported to a target position by the transporter 1A.

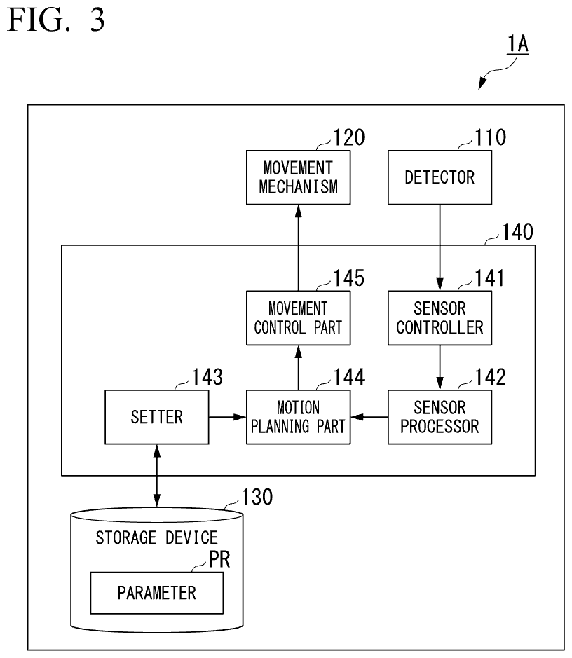

The transporter 1A includes, for example, a mobile cart 2 configured to transport the transport target D and a plurality of detectors for sensing provided on the mobile cart 2. The plurality of detectors include a first detector 10, a second detector 11, and a third detector 12. The mobile cart 2 includes, for example, a loading platform 3 on which the bottom plate D1 is placed on an upper surface side. A plurality of wheels 6 are provided on a lower surface side of the loading platform 3. The wheels 6 constitute a part of a movement mechanism 120 (refer to FIG. 3) as will be described later. The loading platform 3 is configured to travel on the floor surface E by the wheels 6 being driven.

The wheels 6 are driven to move by a general two-wheel independent drive system. Therefore, the transporter 1A is configured to freely move in a target direction. The wheels 6 are configured such that, for example, two pairs of wheels 6 are disposed at a predetermined distance in the direction P in FIG. 1. The number of wheels 6 may be three or less or may be five or more. Note that, the wheels 6 may be driven to move in all directions using special wheels such as omni wheels or mecanum wheels.

When omni wheels, mecanum wheels, or the like are used for the wheels 6, the transporter 1A can move in all directions. The transporter 1A is configured to transport and move the transport target D in accordance with movements of various types of transport targets D.

The loading platform 3 is set to have a height that allows loading platform 3 to enter between the bottom plate D1 of the transport target D and the floor surface E. A height-adjustable lifter 4 is provided on an upper surface side of the loading platform 3. The lifter 4 is controlled by a controller 140 (refer to FIG. 2) as will be described later. The lifter 4 raises the height position of lifter 4 when the loading platform 3 is inserted between the bottom plate D1 and the floor surface E, and operates to support the transport target D from below. The transporter 1A moves while supporting the transport target D from below by the lifter 4 of the loading platform 3, and transports the transport target D. At this time, the transporter 1A moves while supporting a lower portion of the transport target D and rotating the plurality of wheels C on the floor surface E. Therefore, the transporter 1A transports the transport target D. The loading platform 3 may transport the transport target D by friction between a lower surface side of the bottom plate D1 of the transport target D and an upper surface side of the lifter 4. The mobile cart 2 may tow and transport the transport target D in a state in which the transport target D is hooked by a pin or the like without providing the loading platform 3 or the lifter 4. In this way, the transport target D is transported in a state of being integrated with the transporter 1A.

A housing 7 is provided on the loading platform 3, for example, at a position on a front side in the direction P. The controller 140 to be described later is housed in the housing 7. The housing 7 is formed in a rectangular parallelepiped shape. The housing 7 is provided upright from an upper surface side on a front side of the loading platform 3. A rotating light K that alerts the surroundings to an approach of the mobile cart 2 is provided on an upper surface side of the housing 7. The rotating light K has, for example, a light source that rotates to be visible by surrounding workers and alerts them to an approach of the mobile cart 2.

A support member 8 formed of a rod-shaped body is further provided on the upper surface side of the housing 7. The support member 8 is configured to be provided upright. The support member 8 is formed, for example, in a frame shape when viewed from a direction along the direction P, for example. More specifically, the support member 8 is configured by a plurality of rod-shaped members. Specifically, two rod-shaped members (upright members) extending upward are provided upright from the housing 7. A single rod-shaped member (cross member) is connected to the two rod-shaped members to intersect them. The support member 8 may be formed to have a reinforced truss structure to increase bending rigidity in a front-rear direction to prevent vibration. The support member 8 may be formed to have other structures to prevent vibration.

In the transporter 1A, the first detector 10 is provided at a position higher than the floor surface E to detect surrounding information. The first detector 10 is provided at a position higher than the second detector 11 and the third detector 12 with reference to the floor surface E. The transporter 1A uses the first detector 10 at a higher position to detect surrounding information, such as a presence or absence of an object that may obstruct movement, with high accuracy.

The first detector 10 for detecting surrounding objects and the rotating light K are provided at an upper end of the support member 8. The first detector 10 is, for example, a laser range finder (LRF). The first detector 10 scans a laser beam, receives reflected light reflected from an object, and measures a distance to a surface of the object on the basis of a phase difference or an arrival-time difference of the reflected light. The first detector 10 detects first data obtained by scanning a first range around the mobile cart 2. The first detector 10 scans, for example, a predetermined angular range in a horizontal plane direction around itself and detects the first data indicating distances to surfaces of objects around itself at a plurality of points.

In the direction P, the second detector 11 configured to detect second data obtained by scanning a second range around the mobile cart 2 is provided on a front side of the housing 7. The second detector 11 is, for example, an LRF. The second detector 11 scans a laser beam, receives reflected light reflected from an object, and measures a distance to a surface of the object on the basis of a phase difference or an arrival-time difference of the reflected light. The second detector 11 scans, for example, a predetermined angular range in the horizontal plane direction in front of itself and detects the second data indicating distances to surfaces of objects in front of itself at a plurality of points.

In the direction P, the third detector 12 is provided on a rear side of the loading platform 3. The third detector 12 detects third data related to positions of the wheels C provided on a lower part of the transport target D. The third detector 12 is, for example, an LRF. The third detector 12 is attached at a low position to detect the wheels 6. The third detector 12 scans a laser beam, receives reflected light reflected from the wheels 6, and measures distances to surfaces of the wheels 6 on the basis of a phase difference or an arrival-time difference of the reflected light.

The third detector 12 scans, for example, a predetermined angular range in a horizontal plane direction of a laser scanning direction, and detects the third data indicating distances to surfaces of the wheels C in front of itself at a plurality of points. On the basis of the third data detected by the third detector 12, positions of the plurality of wheels C that support the transport target D are detected, and the loading platform 3 can be inserted between the pair of wheels C disposed to face each other in the direction P. The third detector 12 may use not only an LRF but also a depth camera capable of acquiring distance information and may be configured by a plurality of infrared distance sensors.

FIG. 3 is a functional block diagram of the transporter of the first embodiment. As shown in FIG. 3, the transporter 1A includes a detector 110, the movement mechanism 120, a storage device 130, and the controller 140. The detector 110 includes the first detector 10, the second detector 11, and the third detector 12 described with reference to FIGS. 1 and 2. The detector 110 is capable of detecting information on the surroundings of the transporter 1A.

The movement mechanism 120 is a drive mechanism configured to move the transporter 1A. The movement mechanism 120 includes an electric motor (not shown in the drawings) controlled by the controller 140, the wheels 6 shown in FIGS. 1 and 2, and a transmission mechanism configured to transmit a driving force of the electric motor to the wheels 6.

The storage device 130 stores data of various types. For example, the storage device 130 stores various parameters PR necessary for the controller 140 to perform control of the transporter 1A. The parameters PR stored in the storage device 130 are, for example, as follows:
[1] Parameters indicating shapes of the transporter 1A and the transport target D
[2] Parameters indicating wheel configurations of the transporter 1A and the transport target D

Parameters stored in the storage device 130 are not limited to [1] and [2] described above.

The storage device 130 stores parameters indicating shapes and wheel configurations of the transport target D for each type of the transport target D.

The parameters indicating shapes of the transporter 1A and the transport target D include, for example, parameters indicating longitudinal, lateral, and height dimensions of the transporter 1A and the transport target D.

The parameters indicating wheel configurations of the transporter 1A and the transport target D include, for example, the following parameters and the like.
[2A] Parameters indicating whether the wheels 6 provided on the transporter 1A and the wheels C provided on the transport target D are fixed wheels or swivel wheels
[2B] Parameters indicating mounting positions of the wheels 6 with respect to the loading platform 3 of the transporter 1A
[2C] Parameters indicating mounting positions of the wheels C with respect to the bottom plate D1 of the transport target D

The parameters indicating wheel configurations of the transporter 1A and the transport target D are not limited to [2A], [2B], and [2C] described above.

Note that, in addition to the parameters PR described above, the storage device 130 may store, for example, the following information.
[3] Programs of various types used in the controller 140
[4] Information related to environmental fixtures such as surrounding walls or fixed facilities
[5] Detection results of the detector 110, and information necessary for the controller 140 to autonomously drive the transporter 1A (for example, path information)

The storage device 130 is implemented by a storage medium such as a random access memory (RAM), a read only memory (ROM), a hard disk drive (HDD), or a solid state drive (SSD). The storage medium is an example of a computer-readable non-transitory storage medium storing a control program. The control program controls the transporter 1A.

The storage device 130 is housed, for example, in the housing 7 of the transporter 1A, similarly to the controller 140. Note that, the storage device 130 does not necessarily have to be provided in the transporter 1A. For example, the storage device 130 may be provided outside the transporter 1A. In this case, the storage device 130 may be a device that is communicably connected to the controller 140 of the transporter 1A.

The controller 140 includes a sensor controller 141, a sensor processor 142, a setter 143, a motion planning part 144, and a movement control part 145. The sensor controller 141 controls the detector 110 to start or end measurement of surrounding information of the transporter 1A. Also, the sensor controller 141 acquires detection results output from the detector 110.

The sensor processor 142 acquires the detection results of the detector 110 from the sensor controller 141 and performs predetermined processing on the detection results of the detector 110. For example, the sensor processor 142 performs processing for removing noise on the detection results of the detector 110. The sensor processor 142, for example, applies a median filter to the detection results of the detector 110 to remove noise from the detection results of the detector 110. Note that, the sensor processor 142 may perform processing other than the processing for removing noise on the detection results of the detector 110.

The setter 143 sets parameters necessary to create a motion plan for autonomously moving the transporter 1A. The setter 143 reads from the storage device 130 and sets the parameters necessary to create the above-described motion plan. For example, in a case in which the transporter 1A does not transport the transport target D (that is, in a case in which only the transporter 1A travels), the setter 143 reads and sets only parameters related to the transporter 1A. The parameters related to the transporter 1A include, for example, parameters indicating a shape of the transporter 1A, parameters indicating a wheel configuration of the transporter 1A, and the like.

In contrast, in a case in which the transporter 1A transports the transport target D, the setter 143 reads and sets parameters related to the transport target D in addition to the parameters related to the transporter 1A. The parameters related to the transport target D include, for example, parameters indicating the shape of the transport target D, parameters indicating the wheel configuration of the transport target D, and the like. Note that, the setter 143 may set the parameters related to the transporter 1A by default and may change the set parameters according to the type of the transport target D to be transported.

The motion planning part 144 creates a motion plan for autonomously moving the transporter 1A by using the detection results of the detector 110 processed by the sensor processor 142 and the parameters set by the setter 143. For example, the motion planning part 144 determines a path necessary for transporting the transport target D to a target position. In this case, the motion planning part 144 determines a path along which the transport target D can be transported without the movement being hindered by people, obstacles, and the like, regardless of the type of the transport target D. Here, the term “people” refers to workers or the like present at sites of logistics, distribution, manufacturing, and the like. Also, the term “obstacles” refers to other transporters and other transport targets present at the work sites as described above. Other obstacles include objects referred to as so-called environmental fixtures. Other obstacles include, for example, architectural structures such as surrounding wall surfaces and pillars provided at the sites as described above, or fixed equipment.

On the basis of the parameters set by the setter 143, for example, the motion planning part 144 determines, for example, an outline and a rotation center of the state in which the transport target D is supported by the lifter 4 of the transporter 1A and the transporter 1A and the transport target D are integrated. The rotation center also serves as a control center when movement of the transporter 1A is controlled. On the basis of the determined outline and rotation center, the motion planning part 144 determines a minimum proximity distance and a minimum radius of rotation of the transporter 1A in a state in which it is integrated with the transport target D. Then, the motion planning part 144 determines a path along which the transport target D can be transported without the movement being hindered by obstacles or the like by taking into account the determined minimum proximity distance and minimum radius of rotation.

Here, the minimum proximity distance is a distance between the transporter 1A (including the transporter 1A in a state integrated with the transport target D) and an obstacle, and is a distance at which the transporter 1A can be closest to the obstacle without interfering with it. The minimum radius of rotation is the minimum radius of rotation at which the transporter 1A (including the transporter 1A in a state integrated with the transport target D) can rotate without interfering with an obstacle.

The movement control part 145 controls a motion of the transporter 1A by controlling the movement mechanism 120 in accordance with the motion plan created by the motion planning part 144. The movement control part 145 calculates a movement control value by using, for example, a method such as the Dynamic Window Approach or the Elastic Band method. Note that, the movement control part 145 may calculate the movement control value using other methods.

The controller 140 is, for example, a program-executable device (computer) including a processor, a memory, and the like. Each function of the controller 140 is implemented by one or more processors, such as, for example, a central processor (CPU) or a graphics processor (GPU), executing programs stored in a program memory. That is, the controller 140 is implemented by cooperation between software and hardware resources.

However, all or part of the functions of the controller 140 may be implemented by hardware (for example, circuitry) such as a large scale integration (LSI), an application specific integrated circuit (ASIC), a field programmable gate array (FPGA), or programmable logic device (PLD). Also, all or part of the above functions may be implemented by a combination of software and hardware.

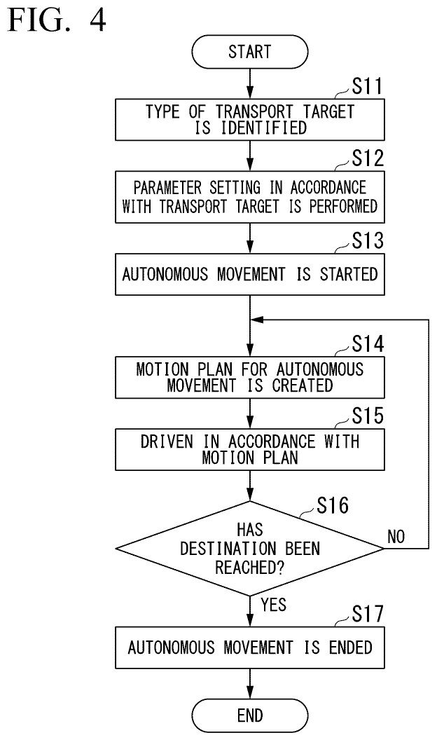

FIG. 4 is a flowchart showing a control method of the first embodiment. The processing of the flowchart shown in FIG. 4 is started each time the transporter 1A transports the transport target D. Note that, for simplicity of explanation, it is assumed here that the transport target D is supported by the lifter 4 of the transporter 1A and that the transporter 1A and the transport target D are in an integrated state.

### Step S11

The controller 140 first identifies the type of the transport target D to be transported. For example, information indicating a type of the transport target D to be transported is stored in advance in the storage device 130. The controller 140 identifies the type of the transport target D to be transported on the basis of the information stored in the storage device 130.

### Step S12

Next, the controller 140 performs parameter setting in accordance with the transport target D. Specifically, the setter 143 of the controller 140 reads the parameters of the transport target D on the basis of the type of the transport target D identified in step S11, and sets them as parameters necessary to create the motion plan for autonomously moving the transporter 1A. For example, the setter 143 sets parameters indicating shapes of the transporter 1A and the transport target D, and parameters indicating wheel configurations of the transporter 1A and the transport target D as the parameters necessary to create the motion plan for autonomously moving the transporter 1A.

### Step S13

Next, the controller 140 performs so-called self-position estimation and starts autonomous movement while observing the surroundings. Specifically, the sensor controller 141 of the controller 140 controls the detector 110 to start measurement of surrounding information of the transporter 1A and acquires detection results output from the detector 110. Also, the sensor processor 142 of the controller 140 acquires the detection results of the detector 110 from the sensor controller 141 and performs predetermined processing on the detection results of the detector 110. For example, the sensor processor 142 performs processing for removing noise on the detection results of the detector 110.

### Step S14

Next, the controller 140 creates a motion plan for autonomous movement. Specifically, the motion planning part 144 of the controller 140 creates the motion plan for autonomously moving the transporter 1A by using the detection results of the detector 110 processed by the sensor processor 142 and the parameters set by the setter 143. For example, the motion planning part 144 determines a path along which the transport target D can be transported to a target position without the movement being hindered by obstacles or the like.

At this time, on the basis of the parameters set by the setter 143, the motion planning part 144 determines, for example, an outline and a rotation center of the state in which the transport target D is supported by the lifter 4 of the transporter 1A and the transporter 1A and the transport target D are integrated. Also, on the basis of the determined outline and rotation center, the motion planning part 144 determines the minimum proximity distance and the minimum radius of rotation of the transporter 1A in a state in which it is integrated with the transport target D. Then, the motion planning part 144 determines a path along which the transport target D can be transported without the movement being hindered by obstacles or the like by taking into account the determined minimum proximity distance and minimum radius of rotation.

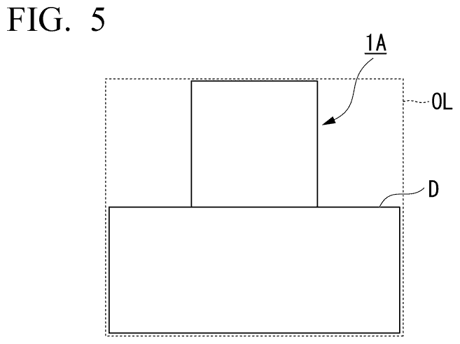

FIG. 5 is a view for explaining a method of calculating the outline in the first embodiment. FIG. 5 is an overall plan view schematically showing the transporter 1A and the transport target D in an integrated state from above in a direction intersecting their proceeding direction. In FIG. 5, planar shapes of the transporter 1A and the transport target D in an integrated state are schematically shown.

Here, the integrated state of the transporter 1A and the transport target D includes a case in which the transport target D is positioned on the transporter 1A by being placed directly or indirectly thereon and a case in which the two are connected directly or indirectly such that the transporter 1A tows and transport the transport target D. In the former case, a cage cart or the like is used for the transport target D. In the latter case, a dolly, a handcart, or the like is used for the transport target D.

The motion planning part 144 determines an outline OL of the transporter 1A and the transport target D in an integrated state by using parameters indicating the shape of the transporter 1A and parameters indicating the shape of the transport target D which have been set by the setter 143. For example, in a plan view, the motion planning part 144 determines a minimum rectangular shape, that includes the outline of the transporter 1A and the transport target D in an integrated state, as the outline OL of the transporter 1A and the transport target D in an integrated state.

Here, the outline OL of the transporter 1A and the transport target D in the integrated state may vary depending on a degree to which the loading platform 3 enters between the bottom plate D1 of the transport target D (refer to FIG. 1) and the floor surface E. Therefore, for example, the degree to which the loading platform 3 enters between the bottom plate D1 of the transport target D and the floor surface E may be detected by using the detection results of the third detector 12, and the outline OL of the transporter 1A and the transport target D in the integrated state may be determined by also taking the detection result into account.

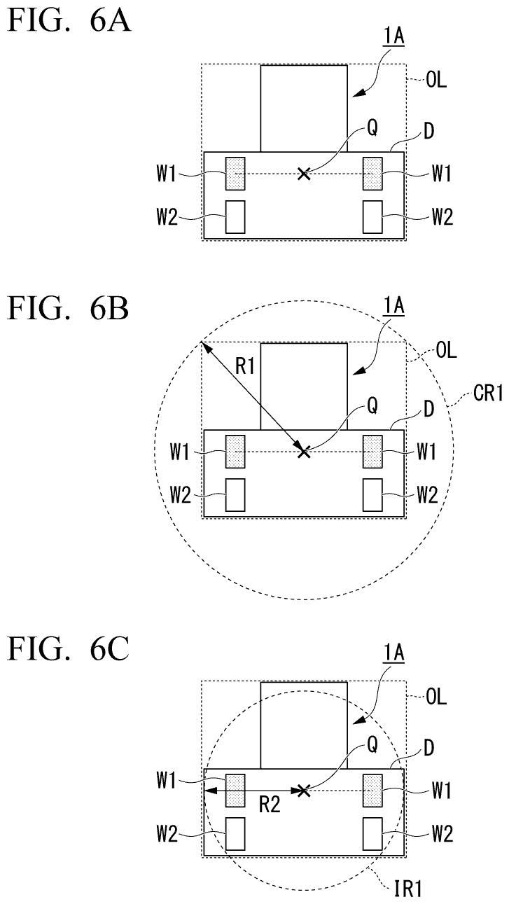

FIGS. 6A to 8C are views for explaining methods of calculating the rotation center, the minimum proximity distance, and the minimum radius of rotation in the first embodiment. Also, FIGS. 6A to 8C are overall plan views schematically showing the transporter 1A and the transport target D in an integrated state from above.

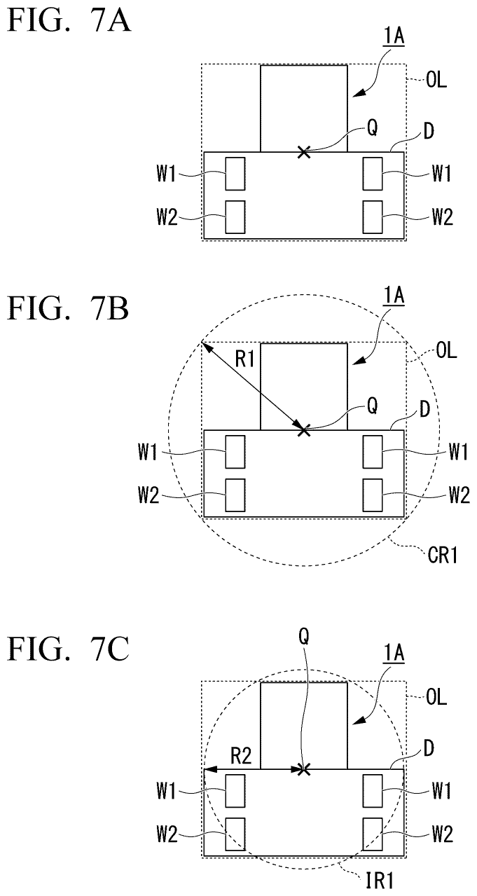

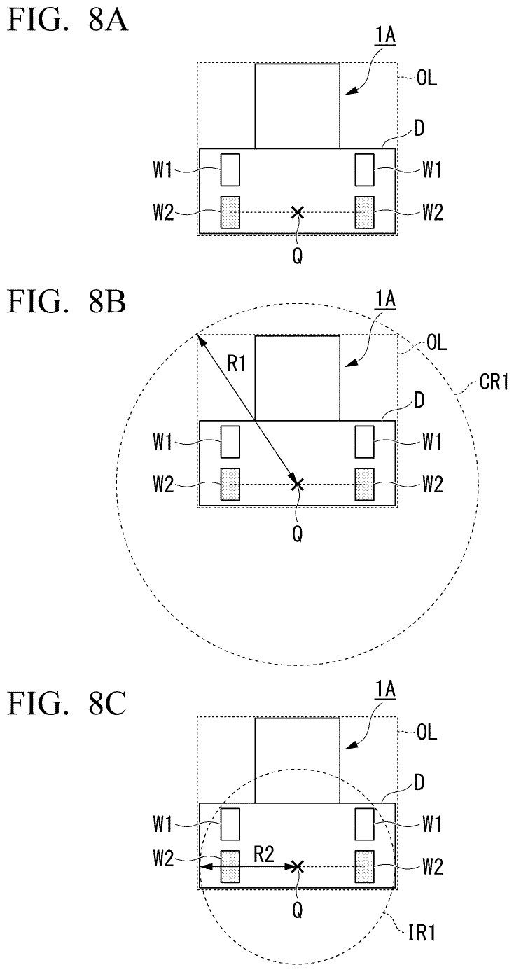

Note that, FIGS. 6A to 6C are explanatory views for a case in which front wheels W1 of the transport target D are fixed wheels and rear wheels W2 are swivel wheels. FIGS. 7A to 7C are explanatory views for a case in which the front wheels W1 and the rear wheels W2 of the transport target D are swivel wheels. FIGS. 8A to 8C are explanatory views for a case in which the front wheels W1 of the transport target D are swivel wheels and the rear wheels W2 are fixed wheels.

As shown in FIG. 6A, if the front wheels W1 of the transport target D are fixed wheels and the rear wheels W2 are swivel wheels, the motion planning part 144, for example, determines a midpoint of the front wheels W1, which are fixed wheels of the transport target D, as a rotation center Q. As shown in FIG. 6B, the motion planning part 144 determines a radius of a circumscribed circle CR1 of the outline OL of the transporter 1A and the transport target D in the integrated state, centered on the rotation center Q, as a minimum radius of rotation R1. Also, as shown in FIG. 6C, the motion planning part 144 determines a radius of an inscribed circle IR1 in a left-right direction of the outline OL of the transporter 1A and the transport target D in the integrated state, centered on the rotation center Q, as a minimum proximity distance R2.

As shown in FIG. 7A, if the front wheels W1 and rear wheels W2 of the transport target D are swivel wheels, the motion planning part 144 determines, for example, a point at which a line passing through a midpoint of the front wheels W1 and a midpoint of the rear wheels W2 of the transport target D intersects an end part in the front of the transport target D as the rotation center Q. As shown in FIG. 7B, the motion planning part 144 determines a radius of the circumscribed circle CR1 of the outline OL of the transporter 1A and the transport target D in the integrated state, centered on the rotation center Q, as the minimum radius of rotation R1. Also, as shown in FIG. 7C, the motion planning part 144 determines a radius of the inscribed circle IR1 in a left-right direction of the outline OL of the transporter 1A and the transport target D in the integrated state, centered on the rotation center Q, as the minimum proximity distance R2.

As shown in FIG. 8A, if the front wheels W1 of the transport target D are swivel wheels and the rear wheels W2 are fixed wheels, the motion planning part 144, for example, determines a midpoint of the rear wheels W2, which are fixed wheels of the transport target D, as the rotation center Q. As shown in FIG. 8B, the motion planning part 144 determines a radius of the circumscribed circle CR1 of the outline OL of the transporter 1A and the transport target D in the integrated state, centered on the rotation center Q, as the minimum radius of rotation R1. Also, as shown in FIG. 8C, the motion planning part 144 determines a radius of the inscribed circle IR1 in a left-right direction of the outline OL of the transporter 1A and the transport target D in the integrated state, centered on the rotation center Q, as the minimum proximity distance R2.

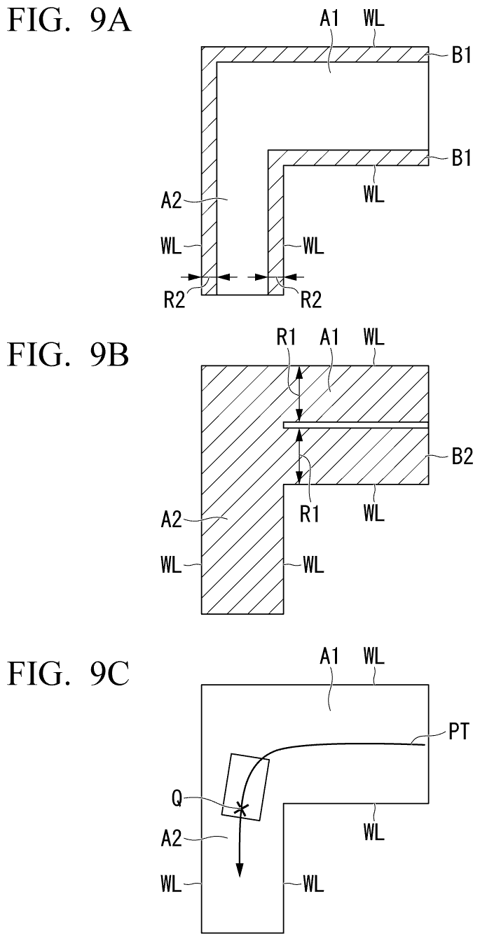

FIGS. 9A to 9C are views for explaining a calculation direction of a path for autonomous travel in the first embodiment. Note that, here, a case of determining a path when traveling from a relatively wide passage A1 to a relatively narrow passage A2 that is bent at 90 degrees with respect to the passage A1 will be described as an example.

As shown in FIG. 9A, the motion planning part 144, for example, sets a prohibited region B1 having a width of the minimum proximity distance R2 from a wall surface WL toward the inside of the passages A1 and A2 by using information regarding environmental fixtures stored in the storage device 130. The term “environmental fixtures” refers to surrounding wall surfaces, fixed equipment, and the like. The reason for setting such a prohibited region B1 is that, if the rotation center Q, which serves as a control center when controlling movement of the transporter 1A, were to pass through the prohibited region B1, the wall surface WL would hinder the travel of the transporter 1A.

Also, as shown in FIG. 9B, the motion planning part 144, for example, sets an attention region B2 having a width of the minimum radius of rotation R1 from the wall surface WL toward the inside of the passages A1 and A2 by using information regarding environmental fixtures stored in the storage device 130. The reason for setting such an attention region B2 is that if the rotation center Q, which serves as a control center when controlling the movement of the transporter 1A, were to pass through the attention region B2, the wall surface WL would hinder the travel of the transporter 1A depending on a posture of the transporter 1A. The attention region B2 is a region that includes the prohibited region B1. Note that, in the example shown in FIG. 9B, since the width of the passage A2 is smaller than a width twice the minimum radius of rotation R1, the entire passage A1 is set as the attention region B2.

The motion planning part 144 determines, for example, a path PT shown in FIG. 9C by using the prohibited region B1 shown in FIG. 9A and the attention region B2 shown in FIG. 9B. Specifically, the motion planning part 144 determines a path along which the rotation center Q, which serves as a control center when controlling movement of the transporter 1A, does not pass through the prohibited region B1. In a case in which the determined path (the rotation center Q) passes through the attention region B2, the motion planning part 144 sets a posture of the transporter 1A so that the wall surface WL does not hinder its travel. In a case in which this setting is performed, information indicating the outline OL of the transporter 1A and the transport target D in the integrated state may be used.

If it is assumed that the wall surface WL would hinder the travel, the motion planning part 144 determines another path different from the previously determined path and along which the rotation center Q does not pass through the prohibited region B1. Then, in a case in which the determined path (the rotation center Q) passes through the attention region B2, the motion planning part 144 sets the posture of the transporter 1A so that the wall surface WL does not hinder its travel. When such processing is performed, for example, the path PT shown in FIG. 9C is determined.

### Step S15

Next, the controller 140 drives the transporter 1A in accordance with the motion plan. Specifically, the movement control part 145 of the controller 140 moves the transporter 1A by controlling the movement mechanism 120 in accordance with the motion plan created by the motion planning part 144. During the process of moving the transporter 1A in this manner, the posture of the transporter 1A is controlled in accordance with the above-described motion plan. The movement control part 145 calculates the movement control value using a method such as the Dynamic Window Approach or the Elastic band method.

### Step S16

Next, the controller 140 determines whether a destination has been reached. If it is determined that the destination has not been reached (in a case of “NO”), the controller 140 repeats the processing of steps S14 and S15. On the other hand, if it is determined that the destination has been reached (in a case of “YES”), the processing proceeds to step S17.

### Step S17

The controller 140 ends the autonomous movement. The controller 140 may perform processing to notify the surroundings that the autonomous movement has ended. For example, the controller 140 may notify the surroundings that the autonomous movement has ended by turning on the rotating light K.

The transporter 1A of the present embodiment includes the detector 110, the movement mechanism 120, the setter 143, the motion planning part 144, and the movement control part 145. The detector 110 is capable of detecting information on the surroundings of the transporter 1A. The movement mechanism 120 moves the transporter 1A. The setter 143 sets parameters necessary to create a motion plan for autonomously moving the transporter 1A according to the type of the transport target D. The motion planning part 144 creates the motion plan using the detection results of the detector 110 and the parameters set by the setter 143. The movement control part 145 controls the movement mechanism 120 in accordance with the motion plan created by the motion planning part 144. Accordingly, it possible to appropriately perform autonomous travel in accordance with the transport target D.

As described above, according to the present embodiment, a transport robot capable of autonomous travel is used as the transporter, and it is possible to flexibly handle and transport different types of transport targets. For example, in a site in which cage carts with different dimensions or wheel configurations (fixed wheels or swivel wheels) are used, any type of cage cart being transported can be transported without being hindered by obstacles or the like.

Note that, in terms of the wheel configuration of the transport target D, the present embodiment are applicable not only to a four-wheel configuration (a configuration with four wheels C), but also to a three-wheel configuration or a configuration with five or more wheels. In the present embodiment, even if the transport target D has a three-wheel configuration or a configuration with five or more wheels, the same effects as in the case of using the four-wheel configuration can be obtained by using the procedures and concepts described above.

### Second Embodiment

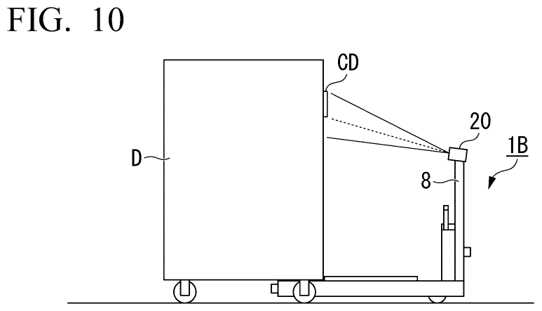

FIG. 10 is a side view showing a configuration of a transporter of a second embodiment. Note that, in FIG. 10, components corresponding to those shown in FIGS. 1 and 2 are denoted by the same reference numerals. As shown in FIG. 10, a transporter 1B of the present embodiment has a configuration in which a reading device 20 is added to the transporter 1A shown in FIGS. 1 and 2. Such a transporter 1B is configured to automatically acquire information (first information) indicating a type of a transport target D, and automatically set parameters necessary to create a motion plan for autonomously moving the transporter 1B on the basis of the acquired information.

The reading device 20 includes, for example, a code reader or a camera, and reads (recognizes) a code CD. The code CD that can be read by the reading device 20 may be a one-dimensional code (barcode) or a two-dimensional code. The code CD includes an identifier configured to specify a type of the transport target D and is affixed to the transport target D of the type specified by the identifier.

It is desirable that the reading device 20 be provided at a position in which the reading device 20 can read the code CD affixed to the transport target D. For example, the reading device 20 is provided at an upper end part of a support member 8 of the transporter 1B. The reading device 20 is configured to read the code CD affixed to the transport target D in a state integrated with the transporter 1B. Note that, the position at which the reading device 20 is provided is merely an example. The reading device 20 may be provided at any position on the transporter 1B as long as the reading device 20 can read the code CD affixed to the transport target D.

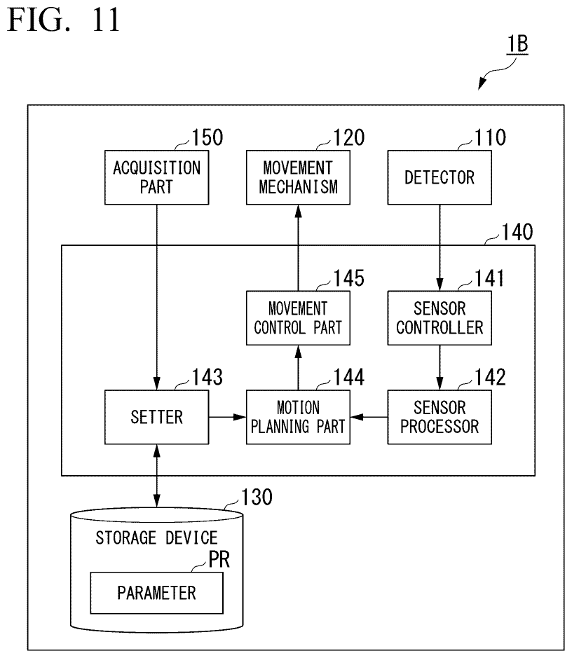

FIG. 11 is a functional block diagram of the transporter of the second embodiment. Note that, in FIG. 11, components corresponding to those shown in FIG. 3 are denoted by the same reference numerals. As shown in FIG. 11, the transporter 1B of the present embodiment has a configuration in which an acquisition part 150 is added to the transporter 1A shown in FIG. 3. The acquisition part 150 includes the reading device 20 shown in FIG. 10, acquires information read by the reading device 20, and outputs the information to a setter 143.

On the basis of the information output from the acquisition part 150, the setter 143 reads from the storage device 130 and sets parameters necessary to create the motion plan for autonomously moving the transporter 1B. Note that, the parameters that the setter 143 reads from the storage device 130 are the same as the parameters that the setter 143 reads from the storage device 130 in the first embodiment.

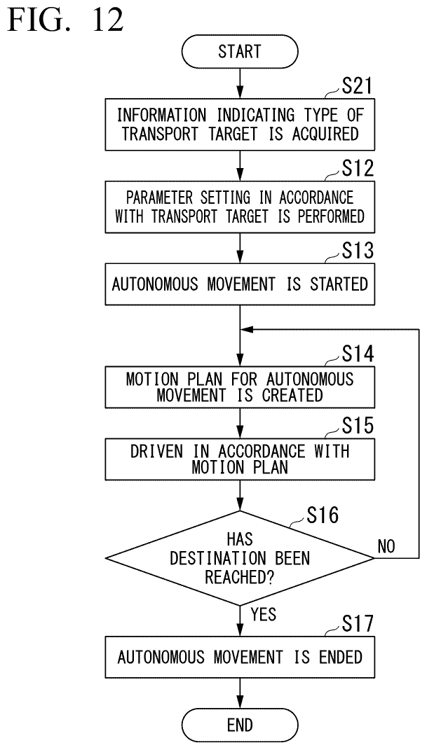

FIG. 12 is a flowchart showing a control method of the second embodiment. Note that, in FIG. 12, steps that are the same as the steps of the flowchart shown in FIG. 4 are denoted by the same reference numerals. The flowchart shown in FIG. 12 has a flow in which step S11 of the flowchart shown in FIG. 4 is replaced with step S21. Note that, for simplicity of explanation, it is assumed here again that the transport target D is supported by a lifter 4 of the transporter 1B and that the transporter 1B and the transport target D are in an integrated state.

### Step S21

A controller 140 first controls the acquisition part 150 to read the code CD. The acquisition part 150 causes the reading device 20 to read the code CD affixed to the transport target D in a state of being integrated with the transporter 1B and acquires the information read by the reading device 20. The acquisition part 150 outputs the acquired information to the setter 143.

### Step S12

Next, the controller 140 performs parameter setting in accordance with the transport target D. Specifically, on the basis of the information output from the acquisition part 150, the setter 143 of the controller 140 reads from the storage device 130 and sets parameters necessary to create the motion plan for autonomously moving the transporter 1B. These parameters are parameters related to the transport target D identified by the information read by the reading device 20.

When the above-described processing ends, steps S13 to S17 are performed in the same manner as in the first embodiment. That is, processing performed includes creating the motion plan for autonomously moving the transporter 1B using the parameters or the like set in step S12, driving the transporter 1B according to the created motion plan, and moving the transporter 1B with the transport target D integrated therewith to a destination.

As described above, the transporter 1B of the present embodiment, similarly to the transporter 1A of the first embodiment, includes the detector 110, the movement mechanism 120, the setter 143, the motion planning part 144, and the movement control part 145. Accordingly, it possible to appropriately perform autonomous travel in accordance with the transport target D. Also, the transporter 1B of the present embodiment includes the acquisition part 150 configured to acquire information indicating the type of the transport target D. Therefore, information indicating the type of the transport target D can be automatically acquired, and parameters necessary to create the motion plan for autonomously moving the transporter 1B can be automatically set on the basis of the acquired information.

### Third Embodiment

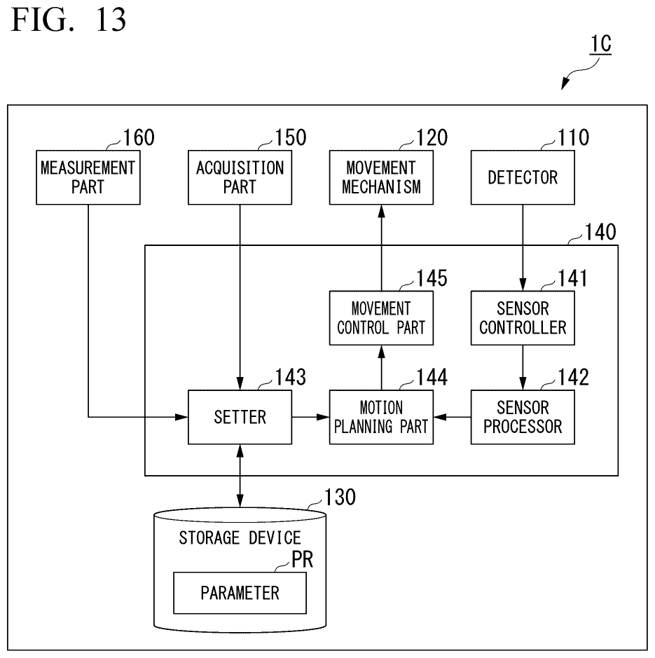

FIG. 13 is a functional block diagram of a transporter of a third embodiment. Note that, in FIG. 13, components corresponding to those shown in FIG. 3 or 11 are denoted by the same reference numerals. As shown in FIG. 13, a transporter 1C of the present embodiment has a configuration in which a measurement part 160 is added to the transporter 1B shown in FIG. 11. Such a transporter 1C is configured to automatically set parameters necessary to create a motion plan for autonomously moving the transporter 1C on the basis of information indicating a type of a transport target D (first information) and information indicating a weight of the transport target D (second information).

The measurement part 160 measures a weight of the transport target D. The measurement part 160 is attached, for example, to a lifter 4 shown in FIGS. 1 and 2 and measures a weight of the transport target D in a state supported by the lifter 4. The measurement part 160 outputs measurement results of the weight of the transport target D to a setter 143 of a controller 140. Note that, the measurement part 160 does not necessarily have to be provided in the transporter 1C. For example, the measurement part 160 may be provided outside the transporter 1C and communicably connected to the controller 140 of the transporter 1C. That is, the transporter 1C may have a configuration in which the measurement results of the measurement part 160 provided externally are acquired by communication.

In the present embodiment, the setter 143 automatically sets the parameters necessary to create the motion plan for autonomously moving the transporter 1C on the basis of the information output from an acquisition part 150 and the measurement results output from the measurement part 160. In setting the parameters, the measurement results output from the measurement part 160 (the weight of the transport target D) are taken into consideration to provide a margin when creating the motion plan for autonomously moving the transporter 1C.

Depending on the weight of the transport target D and a magnitude of an acceleration of the transporter 1C, slipping of wheels 6 of the transporter 1C may occur. For example, when the transport target D having a relatively large weight is transported, if the acceleration at the start of travel is set relatively high, it is conceivable that the wheels 6 may slip and the transporter may not be able to travel. Also, when accelerating or decelerating while transporting the transport target D having a relatively large weight, it is conceivable that the wheels 6 may slip, causing the transporter to deviate from a path determined in the motion plan. Therefore, in the present embodiment, a margin according to the weight of the transport target D is set. Examples of the margin to be set include a margin for a minimum radius of rotation R1 or a minimum proximity distance R2.

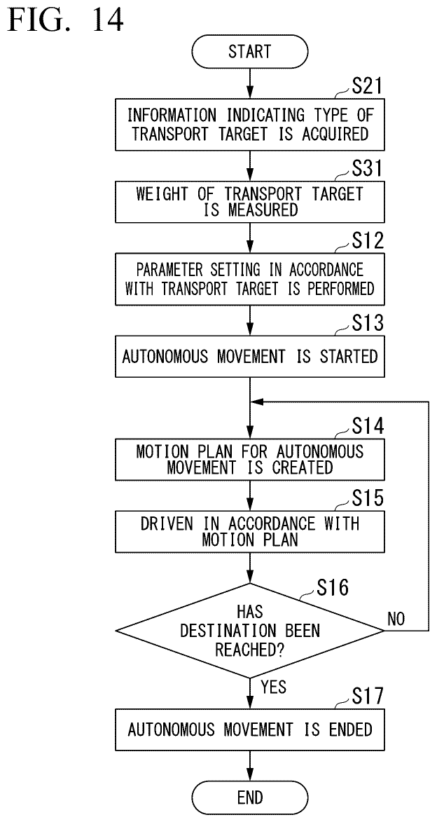

FIG. 14 is a flowchart showing a control method of the third embodiment. Note that, in FIG. 14, steps that are the same as the steps of the flowchart shown in FIGS. 4 and 12 are denoted by the same reference numerals. The flowchart shown in FIG. 14 includes step S31 provided between step S21 and step S12 of the flowchart shown in FIG. 12. Note that, for simplicity of explanation, it is assumed here that the transport target D is supported by the lifter 4 of the transporter 1C and that the transporter 1C and the transport target D are in an integrated state.

### Step S21

The controller 140 first controls the acquisition part 150 to read a code CD. The acquisition part 150 causes a reading device 20 to read the code CD affixed to the transport target D in a state of being integrated with the transporter 1C and acquires the information read by the reading device 20. The acquisition part 150 outputs the acquired information to the setter 143.

### Step S31

Next, the controller 140 controls the measurement part 160 to measure a weight of the transport target D. The measurement part 160 measures the weight of the transport target D in a state integrated with the transporter 1C and supported by the lifter 4. The measurement part 160 outputs the measurement results of the weight of the transport target D to the setter 143.

### Step S12

Next, the controller 140 performs parameter setting in accordance with the transport target D. Specifically, on the basis of the information output from the acquisition part 150 and the measurement results output from the measurement part 160, the setter 143 of the controller 140 reads from the storage device 130 and sets the parameters necessary to create the motion plan for autonomously moving the transporter 1C. These parameters are parameters related to the transport target D identified by the information read by the reading device 20. Also, the parameters also include margins set for the minimum radius of rotation R1 and the minimum proximity distance R2 in accordance with the weight of the transport target D.

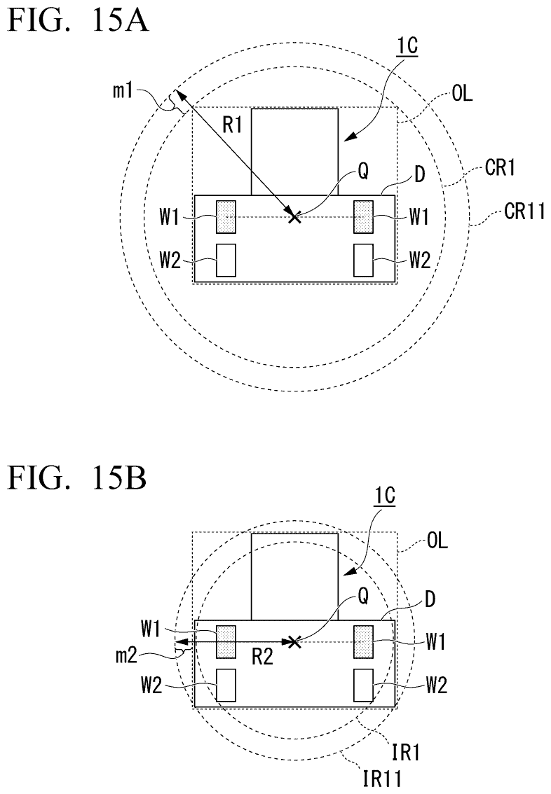

FIGS. 15A and 15B are views for explaining the margins set in the third embodiment. Note that, in FIGS. 15A and 15B, the transport target D (the transport target D shown in FIGS. 6A to 6C) in which the front wheels W1 are fixed wheels and the rear wheels W2 are swivel wheels is taken as an example. In the first embodiment, as described with reference to FIG. 6B, the motion planning part 144 determined a radius of the circumscribed circle CR1 of the outline OL of the transporter 1A and the transport target D in the integrated state, centered on the rotation center Q, as the minimum radius of rotation R1. In contrast, in the present embodiment, as shown in FIG. 15A, a motion planning part 144 determines a radius of a circle CR11 obtained by adding a margin m1 to the radius of the circumscribed circle of an outline OL of the transporter 1A and the transport target D in an integrated state, centered on a rotation center Q, as the minimum radius of rotation R1. In the example shown in FIG. 15A, the margin set for the minimum radius of rotation R1 is the margin m1.

Also, in the first embodiment, as described with reference to FIG. 6C, the motion planning part 144 determined a radius of the inscribed circle IR1 in a left-right direction of the outline OL of the transporter 1A and the transport target D in the integrated state, centered on the rotation center Q, as the minimum proximity distance R2. In contrast, in the present embodiment, as shown in FIG. 15B, the motion planning part 144 determines a radius of a circle IR11 obtained by adding a margin m2 to the radius of the inscribed circle IR1 in a left-right direction of the outline OL of the transporter 1C and the transport target D in an integrated state, centered on the rotation center Q, as the minimum proximity distance R2. In the example shown in FIG. 15B, the margin set for the minimum proximity distance R2 is the margin m2.

When the above-described processing ends, steps S13 to S17 are performed in the same manner as in the first and second embodiments. That is, the processing performed includes creating the motion plan for autonomously moving the transporter 1C using the parameters or the like set in step S12, driving the transporter 1C according to the created motion plan, and moving the transporter 1C with the transport target D integrated therewith to a destination. Note that, when the above-described motion plan is created, the minimum radius of rotation R1 to which the margin m1 is added and the minimum proximity distance R2 to which the margin m2 is added are used.

As described above, the transporter 1C of the present embodiment includes the detector 110, the movement mechanism 120, the setter 143, the motion planning part 144, and the movement control part 145, similarly to the transporter 1A of the first embodiment and the transporter 1B of the second embodiment. Accordingly, it possible to appropriately perform autonomous travel in accordance with the transport target D. Also, the transporter 1C of the present embodiment includes the acquisition part 150 configured to acquire information indicating a type of the transport target D, similarly to the transporter 1B of the second embodiment. Therefore, information indicating a type of the transport target D can be automatically acquired, and parameters necessary to create the motion plan for autonomously moving the transporter 1C can be automatically set on the basis of the acquired information. Furthermore, the transporter 1C of the present embodiment includes the measurement part 160 configured to measure a weight of the transport target D. Therefore, the parameters necessary to create the motion plan for autonomously moving the transporter 1C can be automatically set by also taking into consideration of the weight of the transport target D.

### Fourth Embodiment

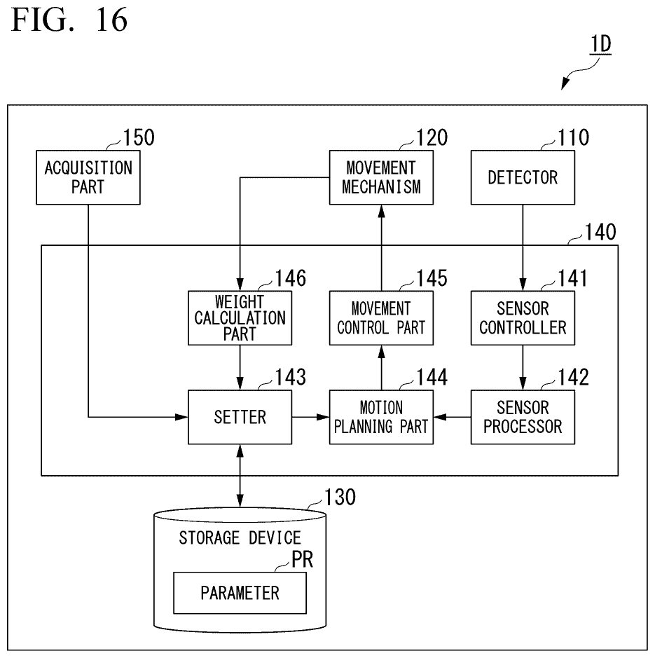

FIG. 16 is a functional block diagram of a transporter of a fourth embodiment. Note that, in FIG. 16, components corresponding to those shown in FIGS. 3, 11, or 13 are denoted by the same reference numerals. As shown in FIG. 16, a transporter 1D of the present embodiment has a configuration in which the measurement part 160 of the transporter 1C shown in FIG. 13 is omitted, and a weight calculation part 146 (calculation part) is provided in a controller 140. Such a transporter 1D has a configuration in which information (second information) indicating a weight of a transport target D is determined by calculation.

The weight calculation part 146 calculates a weight of the transport target D. Specifically, the weight calculation part 146 calculates the weight of the transport target D using measurement information of various types output from a movement mechanism 120. For example, the weight calculation part 146 calculates a torque by using measurement results of a current flowing through an electric motor (not shown in the drawings) provided in the movement mechanism 120, and determines the weight of the transport target D estimated from the torque. Note that, if a torque sensor configured to measure a torque of the electric motor (not shown in the drawings) provided in the movement mechanism 120 is provided, the weight calculation part 146 may determine the weight of the transport target D by using measurement results of the torque sensor. Note that, a method of determining the weight of the transport target D by the weight calculation part 146 is not limited to the above-described method, and any known method can be used.

As described above, the transporter 1D of the present embodiment includes a detector 110, the movement mechanism 120, a setter 143, a motion planning part 144, and a movement control part 145, similarly to the transporter 1A of the first embodiment, the transporter 1B of the second embodiment, and the transporter 1C of the third embodiment. Accordingly, it possible to appropriately perform autonomous travel in accordance with the transport target D. Also, the transporter 1D of the present embodiment includes an acquisition part 150 configured to acquire information indicating a type of the transport target D, similarly to the transporter 1B of the second embodiment and the transporter 1C of the third embodiment. Therefore, information indicating a type of the transport target D can be automatically acquired, and parameters necessary to create a motion plan for autonomously moving the transporter 1D can be automatically set on the basis of the acquired information. Furthermore, the transporter 1D of the present embodiment includes the weight calculation part 146 configured to determine the weight of the transport target D by calculation. Therefore, it is possible to determine the weight of the transport target D even without the measurement part 160 such as that of the transporter 1C of the third embodiment. As a result, also in the present embodiment, the parameters necessary to create the motion plan for autonomously moving the transporter 1D can be automatically set while also taking into account the weight of the transport target D.

### Fifth Embodiment

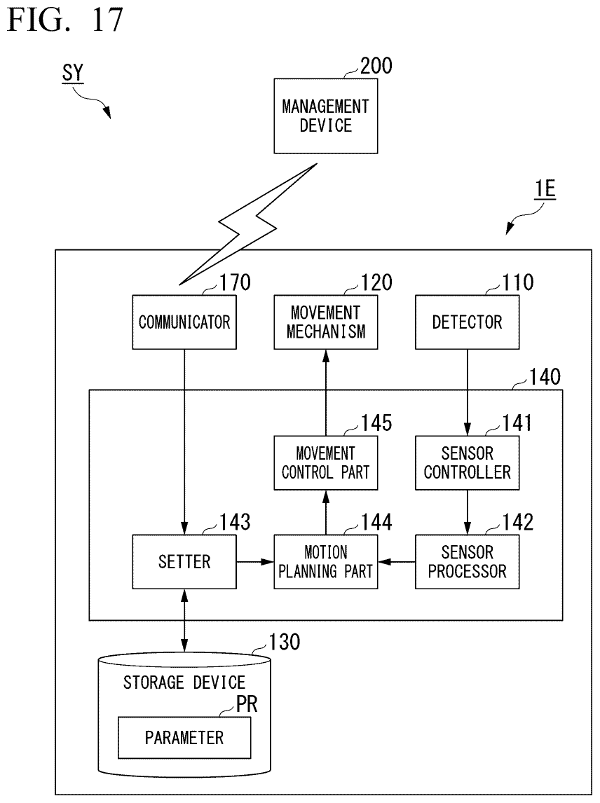

FIG. 17 is a block diagram of a transport system including a transporter of a fifth embodiment. Note that, in FIG. 17, components corresponding to those shown in FIGS. 3 and 11 are denoted by the same reference numerals. As shown in FIG. 17, a transport system SY includes a transporter 1E and a management device 200.

The transporter 1E of the present embodiment has a configuration in which a communicator 170 (acquisition part) is provided instead of the acquisition part 150 of the transporter 1B shown in FIG. 11. Such a transporter 1E is configured to acquire information (first information) indicating a type of a transport target D from the management device 200, and automatically set parameters necessary to create a motion plan for autonomously moving the transporter 1E on the basis of the acquired information.

The communicator 170 is communicably connected to the management device 200 via a network (not shown in the drawings). The communicator 170 performs communication with the management device 200 under the control of the controller 140. The communicator 170 may be communicably connected to the management device 200 via wireless communication, or may be communicably connected via wired communication. Note that, a network (not shown in the drawings) connecting the communicator 170 and the management device 200 may be a network including a path for performing wireless communication and a path for performing wired communication.

The management device 200 comprehensively manages an operation of the transporter 1E. For example, the management device 200 manages the operation of the transporter 1E by instructing the transporter 1E regarding the transport target D to be transported, a transport start position, a transport end position, a transport time, and the like. The management device 200 instructs, for example, an identifier that specifies a type of the transport target D as information indicating the transport target D to be transported. Note that, the management device 200 may manage parameters PR stored in a storage device 130 included in the transporter 1E. When the management device 200 manages the parameters PR, for example, it becomes unnecessary to store the parameters of the transport target D in each transporter 1E.

The operation of the transporter 1E of the present embodiment is basically the same as the operation of the transporter 1B of the second embodiment. A difference between the transporter 1B of the second embodiment and the transporter 1E of the present embodiment is that, the transporter 1B of the second embodiment acquires information indicating the type of the transport target D by reading the code CD affixed to the transport target D, whereas the transporter 1E of the present embodiment acquires such information from the management device 200. In the flowchart showing the operation of the transporter 1E of the present embodiment, step S21 of the flowchart shown in FIG. 12 is replaced with “acquiring information indicating the type of the transport target from the management device 200”. Therefore, detailed description of the operation of the transporter 1E of the present embodiment will be omitted.

As described above, the transporter 1E of the present embodiment, similarly to the transporter 1A of the first embodiment, includes a detector 110, the movement mechanism 120, a setter 143, a motion planning part 144, and a movement control part 145. Accordingly, it possible to appropriately perform autonomous travel in accordance with the transport target D. Also, the transporter 1E of the present embodiment includes the communicator 170 configured to acquire the information indicating the type of the transport target D from the management device 200. Therefore, similarly to the transporter 1B of the second embodiment, the information indicating the type of the transport target D can be automatically acquired, and the parameters necessary to create the motion plan for autonomously moving the transporter 1E can be automatically set on the basis of the acquired information.

Note that, in terms of the wheel configuration of the transport target D, the second, third, fourth, and fifth embodiments are applicable not only to a four-wheel configuration (a configuration with four wheels C), but also to a three-wheel configuration or a configuration with five or more wheels. In the second, third, fourth, and fifth embodiments, even if the transport target D has a three-wheel configuration or a configuration with five or more wheels, the same effects as in the four-wheel configuration can be obtained by using the procedures and concepts described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the inventions. The accompanying claims and their equivalents are intended to cover such forms or modifications as would fall within the scope of the inventions.

The above-described embodiments can be combined as appropriate. For example, the fifth embodiment can be combined with the third embodiment or the fourth embodiment. Therefore, it is also possible to implement the transporters 1D and 1E that are configured to communicate with the management device 200 by including the communicator 170 instead of the acquisition part 150.

In the above-described embodiment, a case in which the transport target D is a cage cart has been described as an example, but the transport target D is not limited to a cage cart. The transport target D may be, for example, a dolly, a handcart, or another object. When the transport target D is a dolly, a handcart, or the like, for example, the transporter and the transport target D are transported in a state of being connected to each other by a connecting member (connecting device). Even when the transport target D is an object other than a cage cart, as long as parameters indicating shapes of the transporter and the transport target D and parameters indicating wheel configurations are available, control similar to that of the transporters 1A to 1E in the embodiments described above can be performed.

In the embodiments described above, a smallest rectangular shape that contains an outline of the transport target D and each of the transporters 1A to 1E in an integrated state has been determined as the outline OL of the transport target D and each of the transporters 1A to 1E in the integrated state. However, it is not necessary to determine the smallest rectangular shape as the outline OL. For example, a rectangular shape having a margin added to the smallest rectangular shape may be determined as the outline OL. When the transport target D is a dolly, a handcart, or the like, the outline is calculated including, for example, the above-described connecting member (connecting device).

With respect to the embodiments described above, the following appendices are disclosed as optional features.

### Appendix 1

A transporter configured to transport a transport target and move autonomously, the transporter including:
a detector configured to detect information on the surroundings of the transporter;
a movement mechanism configured to move the transporter;
a setter configured to set a parameter necessary to create a motion plan for autonomously moving the transporter in accordance with a type of the transport target;
a motion planning part configured to create the motion plan using a detection result of the detector and the parameter set by the setter; and
a movement control part configured to control the movement mechanism in accordance with the motion plan created by the motion planning part.

### Appendix 2

The transporter according to Appendix 1 may further include an acquisition part configured to acquire first information indicating a type of the transport target, and
the setter may set the parameter on the basis of the first information acquired by the acquisition part.

### Appendix 3

In the transporter according to Appendix 2, the setter may set the parameter on the basis of the first information acquired by the acquisition part and second information indicating a weight of the transport target.

### Appendix 4

The transporter according to Appendix 3 may further include a measurement part configured to measure a weight of the transport target to obtain the second information.

### Appendix 5

The transporter according to Appendix 3 may further include a calculation part configured to determine the second information on the basis of a transport condition of the transport target.

### Appendix 6

In the transporter according to any one of Appendices 3 to 5, the acquisition part may obtain the first information by recognizing an identifier affixed to the transport target.

### Appendix 7

In the transporter according to any one of Appendices 3 to 5, the acquisition part may acquire the first information transmitted from a management device that manages the transporter.

### Appendix 8

In the transporter according to any one of Appendices 1 to 7, the motion planning part may create the motion plan by determining, using the parameter set by the setter:
an outline of a state in which the transport target and the transporter are integrated;
a minimum proximity distance to an obstacle in the integrated state of the transport target and the transporter; and
a minimum radius of rotation in the integrated state of the transport target and the transporter.

### Appendix 9

A transport system including:
a transporter according to any one of Appendices 1 to 7; and
a management device configured to transmit information indicating a type of the transport target to the transporter.

### Appendix 10

A controller for a transporter configured to transport a transport target and move autonomously, the transporter including:
a setter configured to set a parameter necessary to create a motion plan for autonomously moving the transporter in accordance with a type of the transport target;
a motion planning part configured to create the motion plan using a detection result of a detector configured to detect information on the surroundings of the transporter and the parameter set by the setter; and
a movement control part configured to control a movement mechanism configured to move the transporter in accordance with the motion plan created by the motion planning part.

### Appendix 11

A control method of controlling a transporter configured to transport a transport target and move autonomously, the method including:
setting, by a setter, a parameter necessary to create a motion plan for autonomously moving the transporter in accordance with a type of the transport target;
creating, by a motion planning part, the motion plan using a detection result of a detector configured to detect information on the surroundings of the transporter and the parameter set by the setter; and
controlling, by a movement control part, a movement mechanism configured to move the transporter in accordance with the motion plan created by the motion planning part.

### Appendix 12

A computer-readable non-transitory storage medium storing a control program, the control program controlling a transporter configured to transport a transport target and move autonomously, the control program causing a computer:
to set a parameter necessary to create a motion plan for autonomously moving the transporter in accordance with a type of the transport target;
to create the motion plan using a detection result of a detector, configured to detect information on the surroundings of the transporter, and the set parameter; and
to control a movement mechanism configured to move the transporter in accordance with the created motion plan.

What is claimed is:

1. A transporter configured to transport a transport target and move autonomously,
the transporter comprising:
a detector configured to detect information on the surroundings of the transporter;
a movement mechanism configured to move the transporter;
a setter configured to set a parameter necessary to create a motion plan for autonomously moving the transporter in accordance with a type of the transport target;
a motion planning part configured to create the motion plan using a detection result of the detector and the parameter set by the setter; and
a movement control part configured to control the movement mechanism in accordance with the motion plan created by the motion planning part.

2. The transporter according to claim 1, further comprising an acquisition part configured to acquire first information indicating a type of the transport target, wherein
the setter sets the parameter on the basis of the first information acquired by the acquisition part.

3. The transporter according to claim 2, wherein
the setter sets the parameter on the basis of the first information acquired by the acquisition part and second information indicating a weight of the transport target.

4. The transporter according to claim 3, further comprising a measurement part configured to measure a weight of the transport target to obtain the second information.

5. The transporter according to claim 3, further comprising a calculation part configured to determine the second information on the basis of a transport condition of the transport target.

6. The transporter according to claim 2, wherein
the acquisition part obtains the first information by recognizing an identifier affixed to the transport target.

7. The transporter according to claim 2, wherein
the acquisition part acquires the first information transmitted from a management device, and
the management device manages the transporter.

8. The transporter according to claim 1, wherein
the motion planning part creates the motion plan by determining, using the parameter set by the setter:
an outline of a state in which the transport target and the transporter are integrated;
a minimum proximity distance to an obstacle in the integrated state of the transport target and the transporter; and
a minimum radius of rotation in the integrated state of the transport target and the transporter.

9. A transport system comprising:
the transporter according to claim 1; and
a management device configured to transmit information indicating a type of the transport target to the transporter.

10. A controller for a transporter configured to transport a transport target and move autonomously,
the transporter comprising:
a setter configured to set a parameter necessary to create a motion plan for autonomously moving the transporter in accordance with a type of the transport target;
a motion planning part configured to create the motion plan using a detection result of a detector configured to detect information on the surroundings of the transporter and the parameter set by the setter; and
a movement control part configured to control a movement mechanism configured to move the transporter in accordance with the motion plan created by the motion planning part.

11. A control method of controlling a transporter configured to transport a transport target and move autonomously,
the method comprising:
setting, by a setter, a parameter necessary to create a motion plan for autonomously moving the transporter in accordance with a type of the transport target;
creating, by a motion planning part, the motion plan using a detection result of a detector configured to detect information on the surroundings of the transporter and the parameter set by the setter; and
controlling, by a movement control part, a movement mechanism configured to move the transporter in accordance with the motion plan created by the motion planning part.

12. A computer-readable non-transitory storage medium storing a control program, the control program controlling a transporter configured to transport a transport target and move autonomously, the control program causing a computer:
to set a parameter necessary to create a motion plan for autonomously moving the transporter in accordance with a type of the transport target;
to create the motion plan using a detection result of a detector, configured to detect information on the surroundings of the transporter, and the set parameter; and
to control a movement mechanism configured to move the transporter in accordance with the created motion plan.
